(19) United States
(12) Patent Application Publication
(10) Pub. No.: US 2010/0192849 A1
(43) Pub. Date: Aug. 5, 2010

(54) HOT-DIP COATING INSTALLATION

(76) Inventors: Peter de Kock, Oberhausen (DE); Ronald Jabs, Moers (DE)

Correspondence Address: ABELMAN, FRAYNE & SCHWAB, 666 THIRD AVENUE, 10TH FLOOR, NEW YORK, NY, 10017, US

(21) Appl. No.: 12/733,737

(22) PCT Filed: Sep. 8, 2008
(86) PCT No.: PCT/EP2008/007320

§ 371 Date: Mar. 16, 2010

(30) Foreign Application Priority Data
Sep. 21, 2007 (DE) 10 2007 045 200.6

(51) Int. Cl. B05C 3/00

(52) U.S. Cl. 118/423

(57) ABSTRACT

The invention relates to a hot-dip coating installation for coating a strip with a liquid metal. A roller formed as a hollow body is provided in the liquid metal for deflecting or stabilizing the strip. The roller is mounted in a bearing on a carrier arm of the hot-dip coating installation by means of a roller journal. The object of the invention is to reduce the rotational resistance, the inertia moment and the slip tendency of the roll in relation to the strip. To this end, the interior of the roller is sealed against the liquid metal and a channel is provided for connecting the interior of the roller to the space region on the periphery of the roll journal. In this way, an excess pressure inside the roller and, therefore, and undesirable deformation of the roller are prevented.

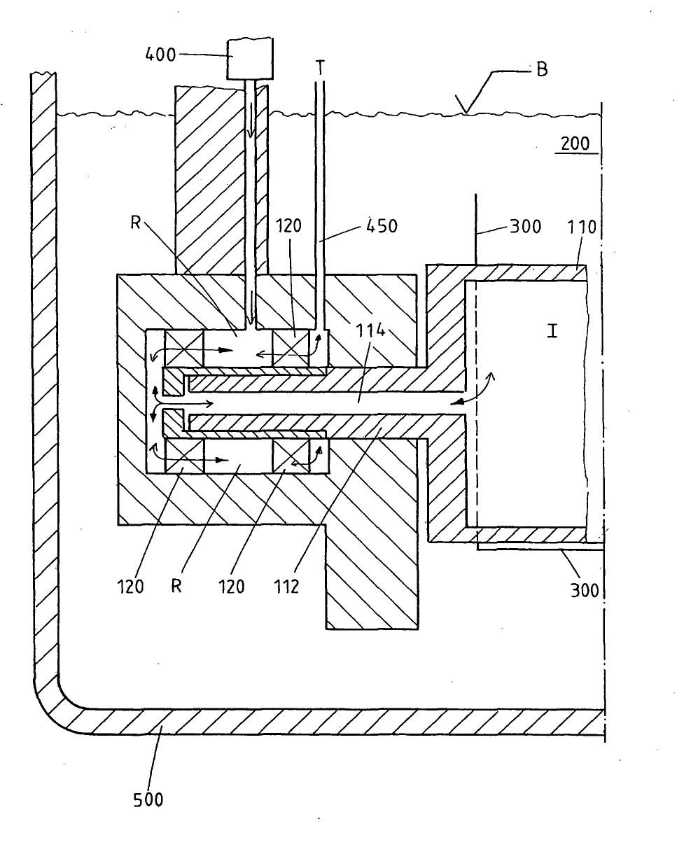

The invention relates to a hot-dip coating installation for coating a strip with a liquid metal.

In the state-of-the art, hot-dip coating installations are basically known. In this installations, a to-be-coated strip, in particular, a steel strip, is displaced through a bath with liquid metal. For guiding and influencing the strip shape and the strip position, different rollers are located in the metal bath in suitable locations. Among the rollers, there is provided a deflection roller that turns around a strip after its entry in the liquid metal before it leaves the bath again. In addition to the deflection roller, smaller correction and stabilization rollers can be provided which, by comparison with the deflection roller, form a relatively small contact region with the strip. Because of a small contact region, the driving forces for these rollers are small.

Such a hot-dip coating installation is disclosed, e.g., in an international publication WO 2006/002822. The hot-dip coating installation disclosed therein includes a roller in form of a deflection or guide roller which is formed as a hollow roller. The roller is rotatably supported on a carrier arm with a bearing. The bearing is mounted in a space region on the periphery of the roller journal. For aerating the space region, there are provided feeding and discharge aeration bores. The roller is formed as a hollow roller with openings in its end surface. Through these openings, the roller is filled during operation of the dip-hot coating installation, i.e., when it is submerged in the metal bath, with the liquid metal, e.g., zinc.

Filling the roller with liquid metal preferably prevents that air in so closed hollow roller expands due to relatively high temperature of the surrounding liquid metal and, under circumstances, would lead to an undesirable deformation of the roller.

Anyway, the described known embodiment of the roller in practice has some drawbacks. The roller with openings in its end surface and filled with liquid metal generates, in particular, at high production speeds, i.e., at high rotational speed, as a result of hydraulic pumping losses in the interior and at the end surface, an increase resistance. Therefore, the roller can produce a slip between the coatable strip and the roller surface. This difference in the displacement speeds can result in damage of the strip surface. The liquid metal in the interior of the hollow roller leads to an increased inertia moment of the roller and, thereby, increases the possibility of slippage.

Proceeding from the state-of-the art, the object of the invention is to so modify a hot-dip coating installation for coating a strip with liquid metal that the rotational resistance, the mass inertia moment, and the slippage tendency of a deflection, correction, or stabilization roller of this installation is reduced.

This object is achieved with the subject matter of claim 1. The hot-dip coating installation is characterized in that the inner space of the roller is sealed against the liquid metal and there is provided a channel that connects the inner space of the roller with the space region at the periphery of the roller journal.

Because its seclusion, the liquid metal cannot penetrate from outside into the hollow inner space of the roller and, therefore, the inner space of the roller remains filled only with gas, e.g., air. The advantage of this consists in that, for one, the inertia moment of the roller and, thus, the slippage tendency are noticeably smaller than that of the roller filled with melt in the state-of-the art. The additional advantage consists in that due to absence of openings for the liquid metal, the rotational resistance of the inventive roller is smaller than of a roller with openings. Simultaneously, the inventive channel insures aeration of the inner space, and equalization of the pressure in the inner space and the space region can be effected through the channel. Built-up of overpressure in the inner space, which can be produced there basically due to high temperatures of the surrounding metal, is effectively prevented by the channel forming a connection between the inner space and the space region. Deformation of the outer surface of the roller by an unacceptable high overpressure is, thus, excluded.

According to a first embodiment of the invention, the hot-dip coating installation has a gas source for subjecting the space region and, through the channel, the inner space of the roller to action of a gas with a predetermined pressure. The channel equalizes in magnitude the predetermined gas pressure. Alternatively, the inventive hot-dip coating installation can have an aeration conduit that subjects the space region to the atmospheric pressure. Then, the inner space of the roller is also subjected to the atmospheric pressure through the channel.

Advantageously, the channel is formed as a bore through the roller journal.

The strip is advantageously a metal strip, in particular, a steel strip.

It is particularly easy, according to the invention, to equip, in particular, an existing hot-dip coating installation in which the rollers are already supported in roller bearings subjected to action of a gas, as with this type of bearings, the space region and feeding and discharge gas conduits are already available. However, the invention can be used in principle, with other types of bearings.

The description is accompanied by a drawing that shows a cross-sectional view of an inventive hot-dip coating installation.

The invention will be described in detail below in form of exemplary embodiments with reference to the drawing FIGURE.

The drawing shows a cross-sectional view of a hot-dip coating installation for coating a strip 300, in particular a steel strip, with a liquid metal 200. The hot-dip coating installation includes a vessel 500 with liquid metal in which a roller 110 that is supported on a carrier arm, is submerged. In the drawing, the roller 110 is formed as a deflection roller for turning around the strip in the liquid metal 200. The roller 110 is formed as a hollow roller with an inner space I and is sealed against the surrounding it, liquid metal 200. The roller 110 has a roller journal with which it is supported in a bearing 120, preferably, a roller bearing. The bearing 120 is mounted on a periphery of the roller journal and is surrounded by a space region R. According to the invention, a channel 114 connects the inner space I of the roller 110 with the space region R.

According to a first exemplary embodiment, the space region R is connected with a gas source 400 and is subjected to a predetermined pressure by this gas. In this way, the liquid metal is prevented from penetration into the space region, which can damage the bearing 120. The gas source 400 and the space region R are, preferably, a part of a closed gas control circuit that insures that the gas pressure in the space region remains, e.g., constant. The communicating channel 114 according to the present invention insures that the inner space I of the Roller is subjected only to a predetermined pressure and not an undesirably high overpressure. In this way, an undesirable deformation of the roller surface and, thus, of the coating of the strip 300 is prevented.

Alternatively, an artificial gas source is provided, or the space region, according to a second economical exemplary embodiment, can be connected by an aeration conduit 450 with atmospheric pressure. Then, the inner space of the roller 110 is aerated through the inventive channel 114 and is subjected to atmospheric pressure, and in this way, overpressure is prevented.

The referenced character B indicates the bath level of the liquid metal 200.

1. A hot-dip coating installation for coating a strip (300) with, initially, liquid metal (200), the installation comprising a roller (110) for deflecting or stabilizing the strip during coating and formed as a hollow body with an inner space (I) and having a roller journal (112) for supporting the bearing,
characterized in that
that the inner space (I) of the roller (110) is sealed against the liquid metal (200); and
there is provided a channel (114) that connects the inner space (I) of the roller (110) with the space region (R) at the periphery of the roller journal.

2. A hot-dip coating installation according to claim 1,
characterized in that
the channel (114) is formed as a bore through the roller journal (112).

3. A hot-dip coating installation according to claim 1,
characterized in that
by a gas source (400) for subjecting the space region (R) and, through the channel (14), the inner space (I) of the roller to action of a gas with a predetermined pressure.

4. A hot-dip coating installation according to claim 3,
characterized by
a control circuit for controlling, e.g., stabilization of pressure in the space region and the inner space.

5. A hot-dip coating installation according to claim 1,
characterized by
an aeration conduit (450) for subjecting the space region (R) and, through the channel (114), the inner space (I) of the roller to atmospheric pressure.

6. A hot-dip coating installation according to claim 1,
characterized by
a vessel for the liquid metal (200), wherein the roller (110) and the space region (R) are submerged, during operation of the installation, in the liquid metal, wherein the space region is sealed against the liquid metal (200) and serves for keeping the bearing free from liquid metal.

7. A hot-dip coating installation according to claim 1,
characterized in that
the strip is a metal strip, e.g., a steel strip.
